(19) United States
(12) Patent Application Publication
(10) Pub. No.: US 2017/0017072 A1
(43) Pub. Date: Jan. 19, 2017

(54) Water Window

(71) Applicant: Kevin Faulkner, Hixson, TN (US)

(72) Inventor: Kevin Faulkner, Hixson, TN (US)

(21) Appl. No.: 14/801,450

(22) Filed: Jul. 16, 2015

(51) Int. Cl. G02B 25/00; G02B 1/04

(52) U.S. Cl. CPC G02B 25/002; G02B 1/041

(57) ABSTRACT

The Water Window allows for the viewing of objects that are 1 to 4 feet deep, at the bottom of beaches, lakes and streams, by placing the device on top of the water and giving a clear magnification of objects that are available to be viewed and picked up by children and adults alike and treasured forever.

### BACKGROUND OF INVENTION

This invention is intended to give beach goers and or avid shell and ocean treasure hunters the ability to see the hidden treasures that lie below 1 to 4 feet of the water on the shore line of Oceans, Streams or Lakes.

Each Vacation we see Hundreds of Young to Old persons looking for treasures under the water. This product makes it so easy.

There is NOT another product that does this simple task.

Thru the years of going to the Gulf coast and hunting for shells and treasures we have had first person experience in “wishing we could see the bottom of the ocean floor”. The Water Window gives you the opportunity to be in the water and pick up the shells and treasures that you want, and not the broken ones, Glass or ocean garbage!

### BRIEF SUMMARY OF INVENTION

The Water Window allows for young and old to be able to stand in the water and place the device on top of the water and clearly see to the bottom with a simple magnification at ×1.5. Users are then able to see the good shells from the bad, good treasures from the bad.

They do not need to wear goggles anymore and STICK their HEAD under the Water to see the shells clearly. They don't pick up live or unwanted creatures . . . because they can see to the bottom of the ocean.

### BRIEF DESCRIPTION OF DRAWINGS

FIG. 1 illustrates an upper view of rectangle version of the Water Window, displaying the front outer side, the right outer side and inside and bottom. The handles are also attached on the left and right ends.

FIG. 2 illustrates the side view of the rectangle version of the Water Window.

FIG. 3 illustrates a front view of the round version of the Water Window.

FIG. 4 illustrates a top view of the round version of the Water Window.

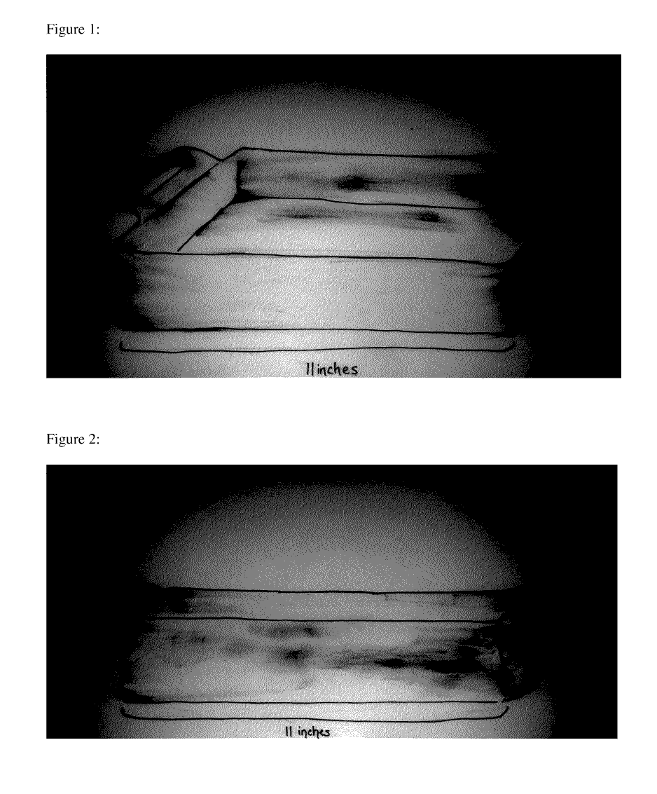

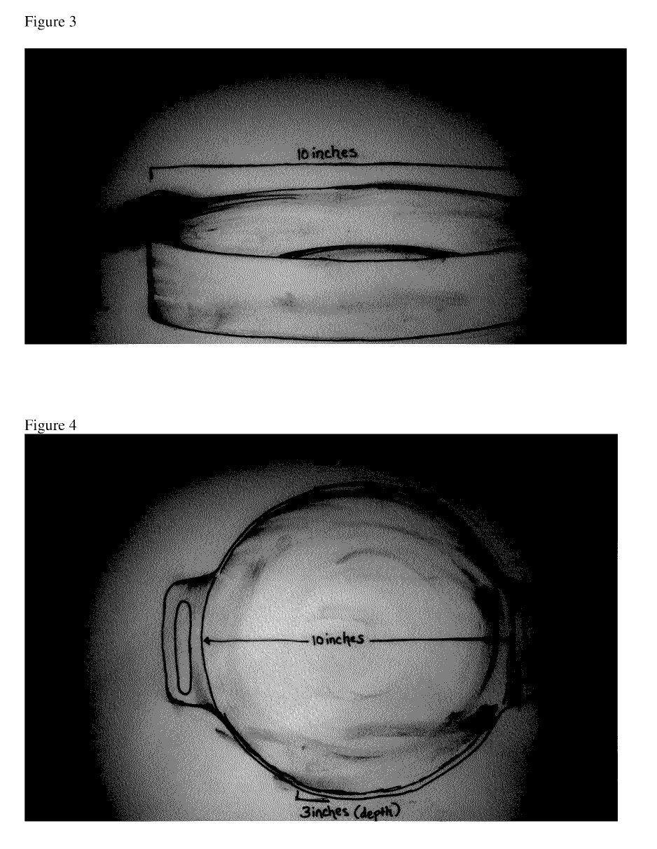

### DETAILED DESCRIPTION

The Primary design will be a vacuum or injection molded piece that has a clear bottom and designs on the sides and handles that are molded into the unit for easy carry and handling in water.

The Handles are attached to the left and right ends of the water window. The handles can be made of the same injection or Blow material or Rope.

The Design of the side of the water window will be a screen printed or inkjet design

For the injection molded polycarbonate piece, Makrolon, Eastar, Styron or Dow Corning MS 1002 can be used.

The water window can also be vacuum or blow forming. For a vacuum piece you can use, Acrylic Sheets (polymethylmethacrylate (PMMA), Poly Carbonate, Vivak or Lexan.

The wood sides, with the clear bottom, which is the “window,” could also be a higher end custom version with a Glass bottom.

The dimensions and shapes of the Water Window are as follows:

### Shapes

The shapes are:

1. Rectangle

2. Square

3. Round

4. Triangle

### Sizes

1. 8×11 rectangle

2. 10×14 rectangle

3. 12×12 square

4. 10×10 square

5. 10″ diameter circle

6. 12″diameter circle

What is claimed is:

1. A simple, child friendly, rectangle, or round clear container that is comprised of a clear vacuum or injection molded piece that makes up the bottom of the device; that is used to magnify objects at the bottom of oceans, lakes and streams that are 1 to 4 feet deep; by placing the device on top of the water, the container can be used by children ages 3 and up; no small parts that can be swallowed or compartments for storage.
